(19) United States
(12) Patent Application Publication
(10) Pub. No.: US 2015/0202986 A1
(43) Pub. Date: Jul. 23, 2015

(54) THERMAL MANAGEMENT SYSTEM FOR ELECTRIC VEHICLE AND ITS CONTROL METHOD

(71) Applicant: CALSONIC KANSEI CORPORATION, Saitama-shi, Saitama (JP)

(72) Inventors: Jun Hatakeyama, Saitama-shi (JP); Takayuki Ishikawa, Saitama-shi (JP); Masashi Koshijima, Sagamihara-shi (JP); Satoshi Ogihara, Fujisawa-shi (JP); Hitoshi Shimonosono, Yokohama-shi (JP)

(73) Assignee: CALSONIC KANSEI CORPORATION, Saitama-shi, Saitama (JP)

(21) Appl. No.: 14/421,377

(22) PCT Filed: Jun. 17, 2013
(86) PCT No.: PCT/JP2013/066597

§ 371 Date: Feb. 12, 2015

(30) Foreign Application Priority Data
Aug. 13, 2012 (JP) 2012-179330

(51) Int. Cl. B60L 11/18; F25B 29/00

(52) U.S. Cl. CPC B60L 11/1874; B60L 11/1875; F25B 29/003

(57) ABSTRACT

A thermal management system for an electric vehicle includes a refrigerant loop for an air conditioner, a refrigerant loop for a battery that allows a refrigerant for the battery to circulate among the battery, an evaporating unit and a heating device, and a thermal management controlling unit that heats the refrigerant for the battery by using the heating device when temperature of the refrigerant for the battery is lower than allowable lower-limit temperature of the battery, and that reduces the temperature of the refrigerant for the battery to be equal to or lower than allowable upper-limit temperature of the battery by increasing an output of the compressing unit when the temperature of the refrigerant for the battery is higher than the allowable upper-limit temperature of the battery.

### TECHNICAL FIELD

The present invention relates to a thermal management system for an electric vehicle that is mounted on the electric vehicle and its control method.

### BACKGROUND ART

An electric vehicle that travels by a driving force of an electric motor cannot use waste heat of an engine at the time of heating, since the engine is not mounted thereon. Further, the amount of heat at the time of heating is not enough even in an electric vehicle on which the engine is mounted, such as a hybrid vehicle, since it does not operate the engine at all times. For this reason, an air conditioning device that is formed by a refrigerant cycle having an electric compressor is used at the time of heating, so as to increase temperature inside a cabin.

However, power accumulated in a battery is consumed by the amount used for operating the air conditioning device, which results in a reduction in cruising distance of the vehicle.

JP2011-68348A discloses an air conditioning system that is provided with a cooling water circuit for cooling a battery, in addition to a refrigerant cycle forming an air conditioning device, and that can exchange heat between the refrigerant and the cooling water. According to this air conditioning system, the battery is heated at the time of charging, and the heat stored in the battery is used when the vehicle is in operation and when the heating is used.

### SUMMARY OF INVENTION

According to the air conditioning system of the above-described patent document, however, the refrigerant cycle is allowed to function as a heat pump cycle at the time of heating, and heat is transferred from the cooling water to the refrigerant via a heat exchanger. When heating heat is not enough, temperature of the battery is reduced to be lower than a desired temperature range. In addition, heat is not absorbed from the cooling water at the time of cooling, and hence the temperature of the battery is increased to be higher than the desired temperature range, when the cooling water is overheated. Thus, it is difficult to control the temperature of the battery to be within the desired temperature range.

It is an object of the present invention to provide a thermal management system for an electric vehicle that can keep the temperature of the battery to be within the desired temperature range, during when the vehicle is in operation, and that can use the heat stored during charging and the waste heat of the battery more efficiently.

According to an aspect of the present invention, provided is a thermal management system for an electric vehicle that is used in the electric vehicle driven by an electric motor, including a refrigerant loop for an air conditioner that includes a compressing unit for compressing a refrigerant for the air conditioner, a condensing unit for condensing the refrigerant for the air conditioner by radiating heat of the refrigerant for the air conditioner, a pressure reducing unit for expanding and reducing pressure of the refrigerant for the air conditioner, and an evaporating unit for evaporating the refrigerant for the air conditioner by allowing the refrigerant for the air conditioner to absorb heat, and that allows the refrigerant for the air conditioner to circulate, a refrigerant loop for a battery that allows a refrigerant for the battery to circulate among the battery that accumulates power to be supplied to the electric motor, the evaporating unit that is common to the refrigerant loop for the air conditioner, and a heating device that heats the refrigerant for the battery, and thermal management controlling means that heats the refrigerant for the battery by using the heating device when temperature of the refrigerant for the battery is lower than allowable lower-limit temperature of the battery, during when an air conditioning unit for adjusting temperature of air inside a cabin is in operation, and that reduces the temperature of the refrigerant for the battery to be equal to or lower than allowable upper-limit temperature of the battery by increasing an output of the compressing unit when the temperature of the refrigerant for the battery is higher than the allowable upper-limit temperature of the battery.

According to another aspect of the present invention, provided is a control method of a thermal management system for an electric vehicle that is used in the electric vehicle driven by an electric motor, in which the thermal management system for the electric vehicle includes a refrigerant loop for an air conditioner that includes a compressing unit for compressing a refrigerant for the air conditioner, a condensing unit for condensing the refrigerant for the air conditioner by radiating heat of the refrigerant for the air conditioner, a pressure reducing unit for expanding and reducing pressure of the refrigerant for the air conditioner, and an evaporating unit for evaporating the refrigerant for the air conditioner by allowing the refrigerant for the air conditioner to absorb heat, and that allows the refrigerant for the air conditioner to circulate, and a refrigerant loop for a battery that allows a refrigerant for the battery to circulate among the battery that accumulates power to be supplied to the electric motor, the evaporating unit that is common to the refrigerant loop for the air conditioner, and a heating device that heats the refrigerant for the battery, in which the control method includes heating the refrigerant for the battery by using the heating device when temperature of the refrigerant for the battery is lower than allowable lower-limit temperature of the battery, during when an air conditioning unit for adjusting temperature of air inside a cabin is in operation, and reducing the temperature of the refrigerant for the battery to be equal to or lower than allowable upper-limit temperature of the battery by increasing an output of the compressing unit when the temperature of the refrigerant for the battery is higher than the allowable upper-limit temperature of the battery.

According to these aspects, it is possible to use the heat of the refrigerant loop for the battery for the air conditioning inside the cabin, while controlling the temperature of the battery to be within the desired temperature range, by using the heat stored in the refrigerant loop for the battery at the time of charging and the waste heat of the battery. This makes it possible to suppress power consumption by the operation of the air conditioning and to suppress the reduction in the cruising distance of the vehicle.

Embodiments and advantages of the present invention will be explained in detail with reference to the attached drawings.

### BRIEF DESCRIPTION OF DRAWINGS

FIG. 1 illustrates the entire constitution of a thermal management system for an electric vehicle according an embodiment of the present invention;

FIG. 2 is a control system chart of the thermal management system for the electric vehicle;

FIG. 3 illustrates an operation state of the thermal management system for the electric vehicle at the time of charging;

FIG. 4 illustrates the operation state of the thermal management system for the electric vehicle at the time of warming up a battery;

FIG. 5 illustrates the operation state of the thermal management system for the electric vehicle at the time of heating;

FIG. 6 illustrates the operation state of the thermal management system for the electric vehicle at the time of cooling;

FIG. 7 is a flowchart illustrating the details of processing of the thermal management system for the electric vehicle;

FIG. 8 is a flowchart illustrating the details of the processing of the thermal management system for the electric vehicle;

FIG. 9 is a time chart illustrating changes in a state of charge and water temperature;

FIG. 10 is a time chart illustrating changes in the state of charge and the water temperature;

FIG. 11 is a time chart illustrating changes in the state of charge and the water temperature;

FIG. 12 illustrates the entire constitution of the thermal management system for the electric vehicle according another embodiment;

FIG. 13 illustrates the entire constitution of the thermal management system for the electric vehicle according still another embodiment;

FIG. 14 illustrates the entire constitution of the thermal management system for the electric vehicle according yet another embodiment;

FIG. 15 illustrates the entire constitution of the thermal management system for the electric vehicle according another embodiment;

FIG. 16 illustrates the entire constitution of the thermal management system for the electric vehicle according still another embodiment; and

FIG. 17 illustrates the entire constitution of the thermal management system for the electric vehicle according yet another embodiment.

### DESCRIPTION OF EMBODIMENTS

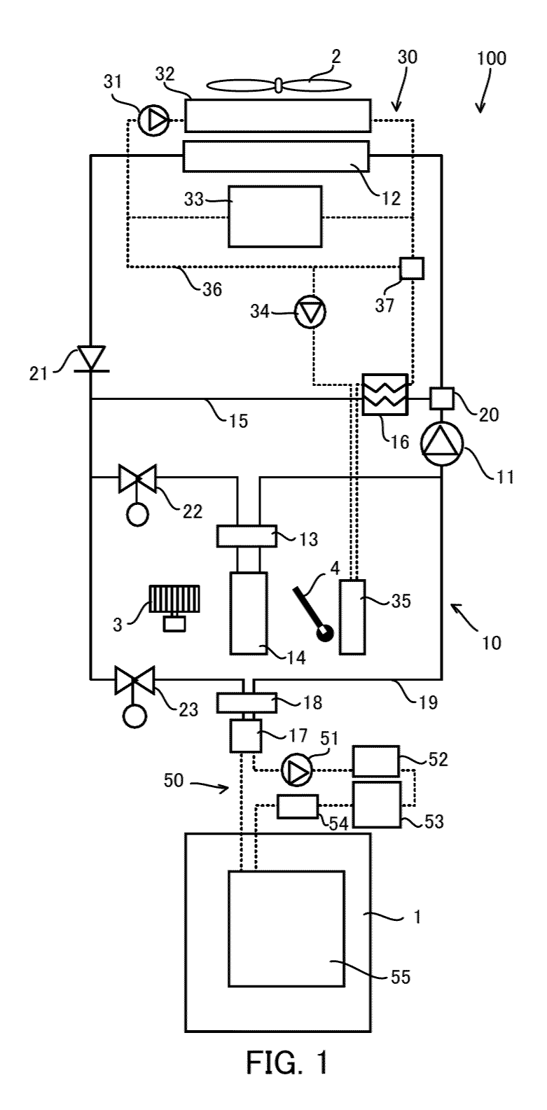

FIG. 1 illustrates the entire constitution of a thermal management system for an electric vehicle 100 according to the present invention.

The thermal management system for the electric vehicle 100 is provided with an air conditioner loop 10, a high water temperature loop 30, and a low water temperature loop 50.

An explanation will be given to the air conditioner loop 10.

The air conditioner loop 10 is a refrigerant circuit that forms a refrigeration cycle in which a refrigerant (such as HFC134a, for example) is circulated in the order of a compressor 11, a condenser 12, an expansion valve 13, and an evaporator 14.

The compressor 11, driven by an electric motor, compresses refrigerant gas and discharges the compressed refrigerant gas having high temperature and high pressure.

The condenser 12 exchanges heat between the compressed refrigerant gas and outside air and radiates the heat of the compressed refrigerant gas to the outside air, so that the compressed refrigerant gas is cooled, condensed, and allowed to be a liquid refrigerant.

The expansion valve 13 expands a high-pressure liquid refrigerant to obtain a low-pressure liquid refrigerant. The expansion valve 13 is a temperature-sensitive expansion valve (TXV), and controls the amount of the refrigerant flowing into the evaporator 14 so that a degree of overheat at an outlet of the evaporator 14 is in a predetermined state that is set in advance.

The evaporator 14 exchanges heat between the liquid refrigerant and air inside a cabin and absorbs the heat of the air inside the cabin to cool the air inside the cabin, and evaporates the liquid refrigerant to obtain the refrigerant gas.

The air conditioner loop 10 is further provided with a bypass passage 15 that connects a downstream side of the compressor 11 and a downstream side of the condenser 12, a water condenser 16 that is provided in the middle of the bypass passage 15, a chiller 17 that is provided in parallel with the evaporator 14, and a passage 19 that allows the refrigerant to flow through an expansion valve 18.

The water condenser 16 is a heat exchanger that is provided on the high water temperature loop 30, and that exchanges heat between the refrigerant flowing through the bypass passage 15 and the refrigerant flowing through the high water temperature loop 30. The chiller 17 is a heat exchanger that is provided on the low water temperature loop 50, and that exchanges heat between the refrigerant in the air conditioner loop 10 and the low water temperature loop 50. Inflow/outflow of the refrigerant in/from the chiller 17 is performed via the temperature-sensitive expansion valve (TXV), similarly to the evaporator 14.

The air conditioner loop 10 is further provided with a three way valve 20 that can switch passages so that the refrigerant, discharged from the compressor 11, is allowed to flow to at least either one of the condenser 12 side and the bypass passage 15 side, a check valve 21 that prevents backflow of the refrigerant, flowing through the bypass passage 15, to the condenser 12 side, an evaporator solenoid valve 22 that can open/close the refrigerant passage to the evaporator 14, and a chiller solenoid valve 23 that can open/close the refrigerant passage to the chiller 17.

Next, an explanation will be given to the high water temperature loop 30.

The high water temperature loop 30 allows cooling water (such as an antifreeze, for example) to circulate in the order of a radiator pump 31, a radiator 32, and a motor 33, and also in the order of an H/C pump 34, a heater core 35, and the water condenser 16. Namely, the high water temperature loop 30 is a cooling water circuit that allows the heat, absorbed in at least either one of the motor 33 and the water condenser 16, to be radiated in at least either one of the radiator 32 and the heater core 35.

The radiator pump 31 sends the cooling water to the radiator 32. The radiator 32 cools the cooling water by exchanging heat between the cooling water and air outside the cabin, and releasing the heat of the cooling water to the outside of the cabin. The motor 33 is an electric motor for driving the vehicle, and drives the vehicle by the supply of power from a battery 1.

The H/C pump 34 sends the cooling water to the heater core 35. The heater core 35 cools the cooling water by exchanging heat between the cooling water and the air inside the cabin, releasing the heat of the cooling water into the cabin, and heating the air inside the cabin. The water condenser 16 is a heat exchanger that exchanges heat between the refrigerant in the air conditioner loop 10 and the cooling water in the high water temperature loop 30, and that transfers the heat from the refrigerant to the cooling water.

The high water temperature loop 30 is further provided with a bypass passage 36 that connects a downstream side of the water condenser 16 and an upstream side of the radiator pump so as to bypass the motor 33, and a water switching valve 37 that can switch passages so that the cooling water on the downstream side of the water condenser 16 is flowed to at least either one of the motor 33 side and the bypass passage 36 side.

Next, an explanation will be given to the low water temperature loop 50.

The low water temperature loop 50 allows the cooling water (such as the antifreeze, for example) to circulate in the order of a battery pump 51, a DC/DC converter 52, an inverter 53, a hot water heater 54, a water jacket 55, and the chiller 17.

The battery pump 51 sends the cooling water to the DC/DC converter 52. The DC/DC converter 52 steps down the power supplied from the battery 1 to, for example, 12 V, and outputs it to a power system (a sub-battery or the like) that is different from a drive system (the motor 33, the inverter 53 and the like). The inverter 53 converts DC power of the battery 1 into AC power, according to a required driving force of the vehicle, and supplies it to the motor 33. The battery 1, having a heat insulation structure that can keep a heat insulation property between the battery 1 and the outside air, accumulates the power to be supplied to the motor 33 for driving the vehicle.

The hot water heater 54, such as a PTC heater or the like, heats the cooling water by the heat generated by using the power supplied from the battery 1. The water jacket 55 is a heat exchanger that exchanges heat between the cooling water and the battery 1, and is provided next to the battery 1 so as to increase a contact area with a battery module. The chiller 17 is the heat exchanger that exchanges heat between the cooling water in the low water temperature loop 50 and the refrigerant in the air conditioner loop 10, and that transfers the heat from the refrigerant to the cooling water.

The thermal management system for the electric vehicle 100 is formed by the above-described three loops, and heat is transferred among the respective loops.

Now, an explanation will be given to delivery of heat between the vehicle and the air outside the cabin.

The radiator 32 in the high water temperature loop 30 and the condenser 12 in the air conditioner loop 10 are disposed at positions receiving travelling wind, at the time when the vehicle is travelling. Thereby, during travelling, it is possible to radiate heat from the radiator 32 and the condenser 12 by the travelling wind. In addition, it is also possible to provide an electric-powered condenser fan 2 next to the radiator 32 and the condenser 12, and to forcibly radiate the heat from the radiator 32 and the condenser 12 by operating the condenser fan 2.

Moreover, delivery of heat between the vehicle and the air inside the cabin will be explained.

An air conditioning unit that adjusts temperature inside the cabin is provided with a blower fan 3, the evaporator 14, a mix door 4, and the heater core 35.

Air, taken in by the blower fan 3 selectively from the air inside the cabin or from the outside air, is cooled by the evaporator 14, reheated according to an opening degree of the mix door 4, and thereafter, blown into the cabin from blowout holes to the cabin.

The air may be taken into the air conditioning unit by outside air introduction or inside air circulation, and switching between the outside air introduction and the inside air circulation is made according to an opening degree of an intake door that is provided at the most upstream part of the air conditioning unit. The opening degree of the mix door 4 is set according to target blowout temperature that is set based on set temperature, a detection value of a solar radiation amount sensor and the like. A blowout ratio among a defroster blowout hole, a vent blowout hole, and a foot blowout hole, as the blowout holes to the cabin, is adjusted by opening degrees of a defroster door, a vent door, and a foot door that adjust the opening degrees of the respective blowout holes.

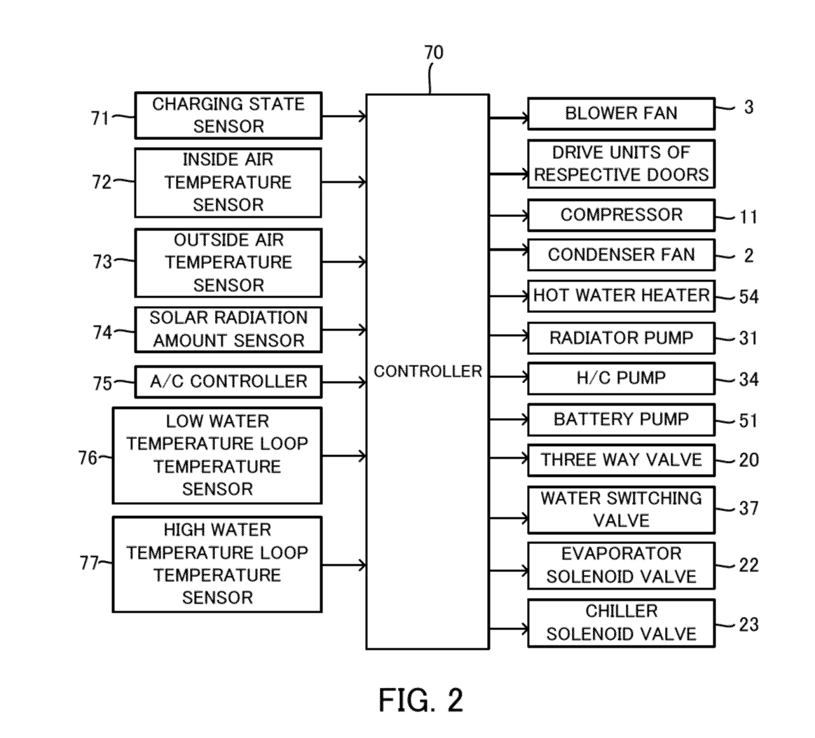

Next, a controller 70 that controls the operation of the thermal management system for the electric vehicle 100 will be explained with reference to FIG. 2.

The controller 70 receives a sensing signal of a charging state sensor 71 that senses that the vehicle is in a charging state, a detecting signal of an inside air temperature sensor 72 that detects the temperature of the air inside the cabin, a detecting signal of an outside air temperature sensor 73 that detects the temperature of the air outside the cabin, a detecting signal of a solar radiation amount sensor 74 that detects a solar radiation amount to be received by the vehicle, set information, such as set temperature and air quantity, that is set by a driver operating an A/C controller 75 installed in an instrument panel, a detecting signal of a low water temperature loop temperature sensor 76 that detects the temperature of the cooling water circulating through the low water temperature loop 50, and a detecting signal of a high water temperature loop temperature sensor 77 that detects the temperature of the cooling water circulating through the high water temperature loop 30.

The controller 70 processes the received various signals, and controls the air quantity of the blower fan 3, the opening degrees of the respective doors, a rotation speed of the compressor 11, the operation of the condenser fan 2, the operation of the hot water heater 54, the operation of the radiator pump 31, the operation of the H/C pump 34, the operation of the battery pump 51, the switching of the three way valve 20, the switching of the water switching valve 37, the opening/closing of the evaporator solenoid valve 22, and the opening/closing of the chiller solenoid valve 23.

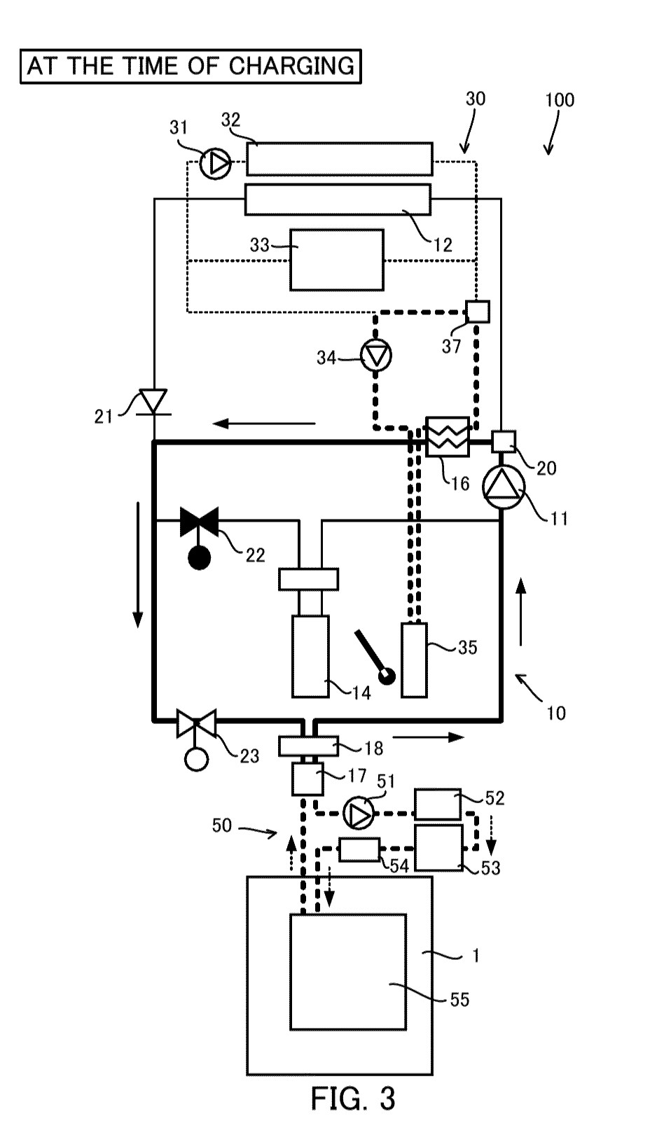

Next, the operation of the thermal management system for the electric vehicle 100 will be explained with reference to FIG. 3 to FIG. 6. In the drawings, the part illustrated by a thick line, among the air conditioner loop 10, the high water temperature loop 30, and the low water temperature loop 50, is the circuit through which the refrigerant or the cooling water flows.

FIG. 3 is a circuit diagram illustrating the operation of the thermal management system for the electric vehicle 100 at the time of charging the battery.

In the air conditioner loop 10, the compressor 11 operates and allows the refrigerant to circulate in the order of the three way valve 20, the water condenser 16, the chiller solenoid valve 23, the expansion valve 18, and the chiller 17. As the refrigerant circulation path is restricted by the three way valve 20 and the check valve 21, the refrigerant does not flow to the condenser 12 side. The refrigerant circulation path is also restricted by shut-off of the evaporator solenoid valve 22, and hence the refrigerant does not flow to the evaporator 14.

In the low water temperature loop 50, the battery pump 51 operates and allows the cooling water to circulate in the order of the DC/DC converter 52, the inverter 53, the hot water heater 54, the water jacket 55, and the chiller 17.

In the high water temperature loop 30, the H/C pump 34 operates and allows the cooling water to circulate in the order of the heater core 35, the water condenser 16, and the water switching valve 37. As the cooling water circulation path is restricted by the water switching valve 37, and the radiator pump 31 is not operated, the cooling water does not flow to the motor 33 and the radiator 32.

Thus, at the time of charging the battery, charging heat of the battery 1 and a heat loss of the inverter 53 and the DC/DC converter 52 are absorbed in the cooling water in the low water temperature loop 50, and the cooling water is heated by the hot water heater 54 as necessary. Excess heat of the cooling water is transferred, in the chiller 17, to the refrigerant in the air conditioner loop 10.

Further, in the air conditioner loop 10, heat is transferred, in the water condenser 16, from the high-temperature refrigerant on the discharge side of the compressor 11 to the cooling water in the high water temperature loop 30, and excess heat of the low water temperature loop 50 is absorbed in the chiller 17. In the high water temperature loop 30, the cooling water, heated in the water condenser 16, is circulated to the heater core 35.

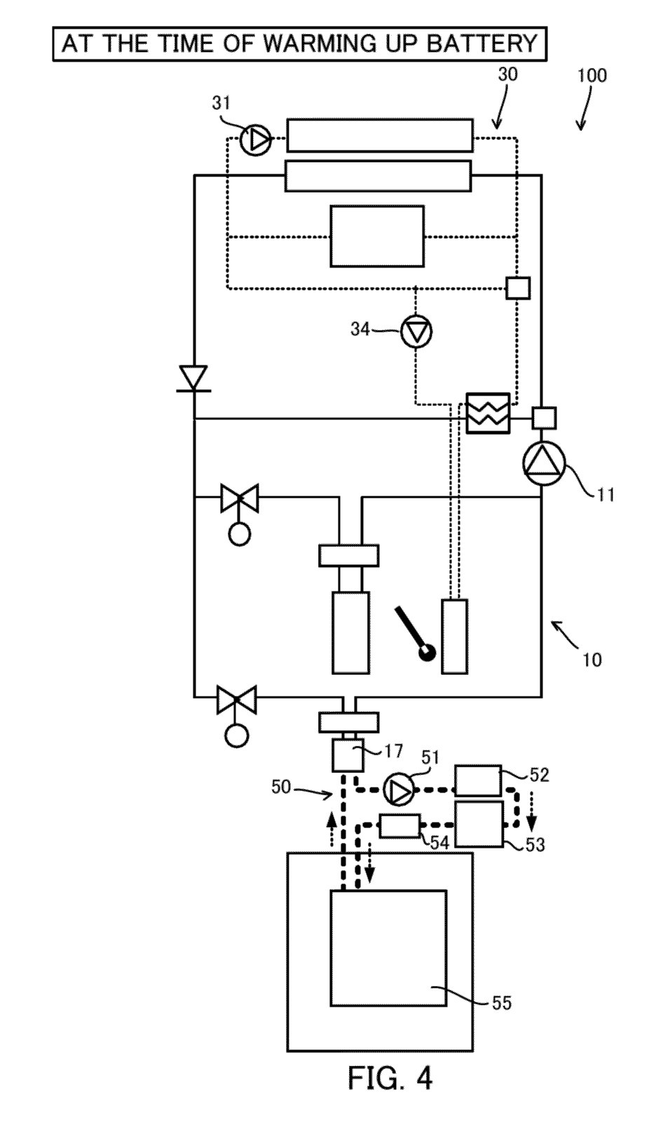

FIG. 4 is a circuit diagram illustrating the operation of the thermal management system for the electric vehicle 100 at the time of warming up the battery.

In this case, the compressor 11, the radiator pump 31, and the H/C pump 34 do not operate, and hence the refrigerant and the cooling water do not circulate through the air conditioner loop 10 and the high water temperature loop 30.

In the low water temperature loop 50, the battery pump 51 operates and allows the cooling water to circulate in the order of the DC/DC converter 52, the inverter 53, the hot water heater 54, the water jacket 55, and the chiller 17. Further, the hot water heater 54 is operated to warm up the cooling water. As the refrigerant is not flowing through the air conditioner loop 10, the heat exchange is not performed in the chiller 17.

Thus, at the time of warming up the battery, the charging heat of the battery 1 and the heat loss of the inverter 53 and the DC/DC converter 52 are absorbed in the cooling water in the low water temperature loop 50, and the cooling water is heated by the hot water heater 54 and circulated with the appropriate temperature, so as to warm up the battery 1.

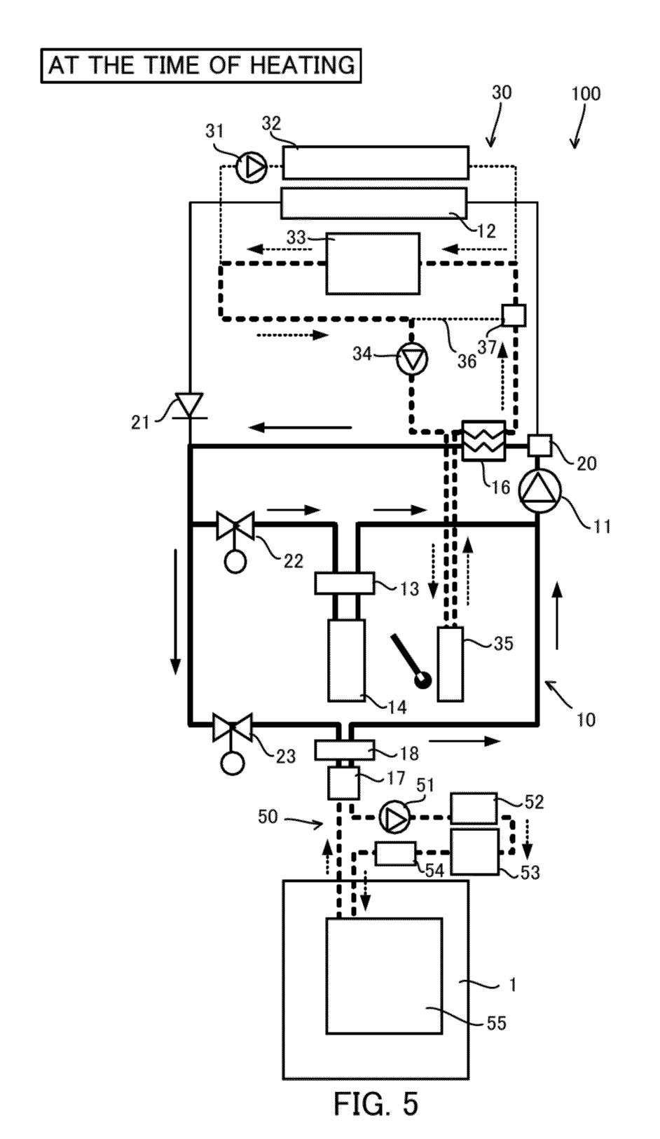

FIG. 5 is a circuit diagram illustrating the operation of the thermal management system for the electric vehicle 100 at the time of heating.

In the air conditioner loop 10, the compressor 11 operates and allows the refrigerant to circulate in the order of the three way valve 20, the water condenser 16, the evaporator solenoid valve 22, the expansion valve 13, and the evaporator 14 and, in parallel with this, in the order of the three way valve 20, the water condenser 16, the chiller solenoid valve 23, the expansion valve 18, and the chiller 17. As the refrigerant circulation path is restricted by the three way valve 20 and the check valve 21, the refrigerant does not flow to the condenser 12 side.

In the low water temperature loop 50, the battery pump 51 operates and allows the cooling water to circulate in the order of the DC/DC converter 52, the inverter 53, the hot water heater 54, the water jacket 55, and the chiller 17.

In the high water temperature loop 30, the H/C pump 34 operates and allows the cooling water to circulate in the order of the heater core 35, the water condenser 16, the water switching valve 37, and the motor 33. As the cooling water circulation path is restricted by the water switching valve 37, the cooling water does not flow through the bypass passage 36 between the water switching valve 37 and the H/C pump 34. In addition, as the radiator pump 31 does not operate, the cooling water does not flow to the radiator 32.

Thus, at the time of heating, the charging heat of the battery 1 and the heat loss of the inverter 53 and the DC/DC converter 52 are absorbed in the cooling water in the low water temperature loop 50, and the cooling water is heated by the hot water heater 54 as necessary. Excess heat of the cooling water is transferred, in the chiller 17, to the refrigerant in the air conditioner loop 10.

Further, in the air conditioner loop 10, heat is transferred, by the water condenser 16, from the high-temperature refrigerant on the discharge side of the compressor 11 to the cooling water in the high water temperature loop 30, and the excess heat of the low water temperature loop 50 is absorbed in the chiller 17. In the high water temperature loop 30, the cooling water, heated by the water condenser 16 and waste heat of the motor 33, is circulated to the heater core 35.

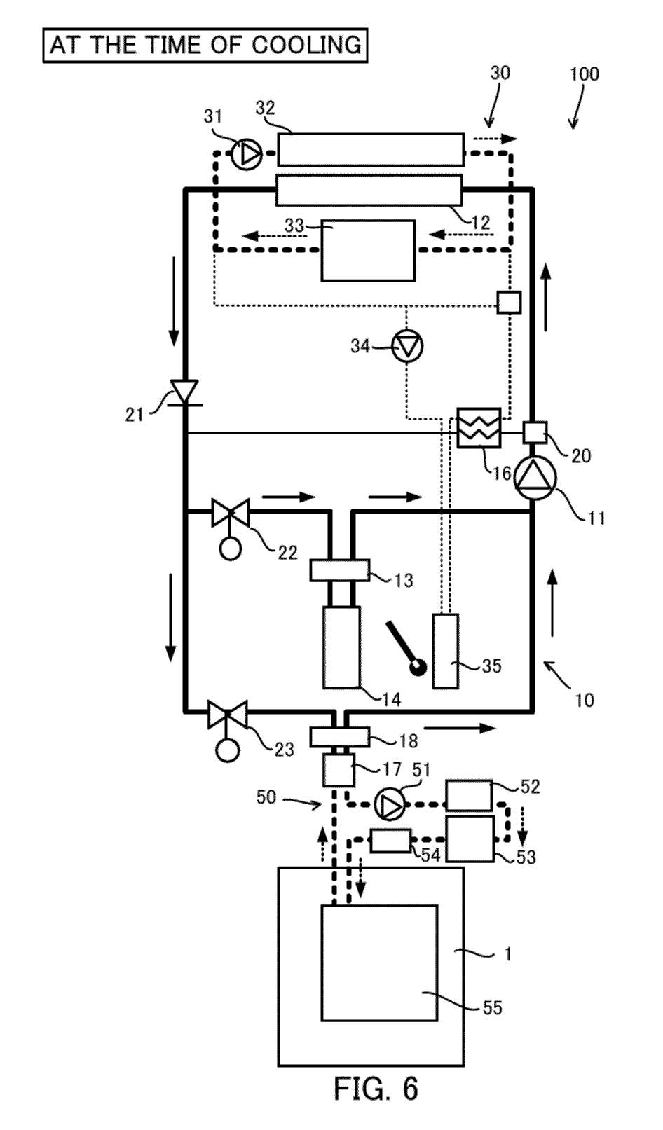

FIG. 6 is a circuit diagram illustrating the operation of the thermal management system for the electric vehicle 100 at the time of cooling.

In the air conditioner loop 10, the compressor 11 operates and allows the refrigerant to circulate in the order of the three way valve 20, the condenser 12, the check valve 21, the evaporator solenoid valve 22, the expansion valve 13, and the evaporator 14. In parallel with this, the air conditioner loop 10 is branched off at the position downstream of the check valve 21, and the refrigerant is circulated in the order of the chiller solenoid valve 23, the expansion valve 18, and the chiller 17. As the refrigerant circulation path is restricted by the three way valve 20, the refrigerant does not flow to the water condenser 16 side.

In the low water temperature loop 50, the battery pump 51 operates and allows the cooling water to circulate in the order of the DC/DC converter 52, the inverter 53, the hot water heater 54, the water jacket 55, and the chiller 17.

In the high water temperature loop 30, the radiator pump 31 operates and allows the cooling water to circulate in the order of the radiator 32, and the motor 33. As the H/C pump 34 does not operate, the cooling water does not flow to the heater core 35, and circulates between the motor 33 and the radiator 32.

Thus, at the time of cooling, the charging heat of the battery 1 and the heat loss of the inverter 53 and the DC/DC converter 52 are absorbed in the cooling water of the low water temperature loop 50. Excess heat of the cooling water is transferred, in the chiller 17, to the refrigerant in the air conditioner loop 10.

Further, in the air conditioner loop 10, heat is absorbed, in the evaporator 14, from air supplied to the cabin, the excess heat of the low water temperature loop 50 is absorbed in the chiller 17, and heat is radiated, in the condenser 12, from the refrigerant to the outside air. In the high water temperature loop 30, the waste heat of the motor 33 is released by the radiator 32.

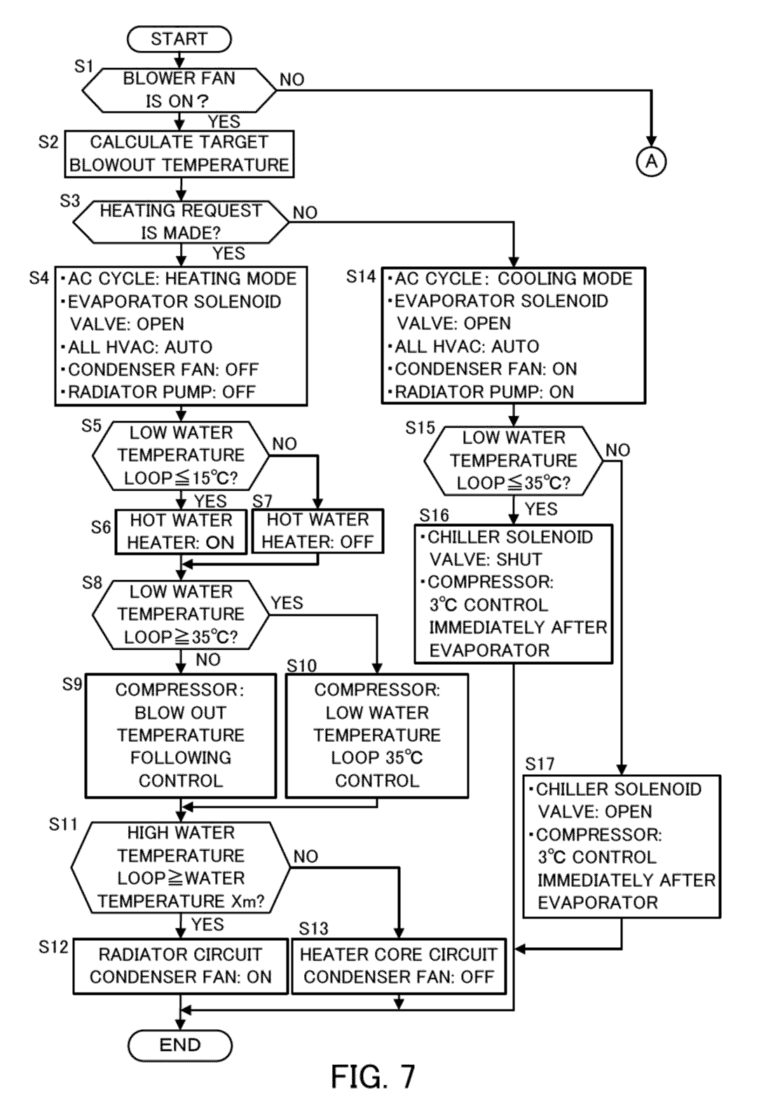

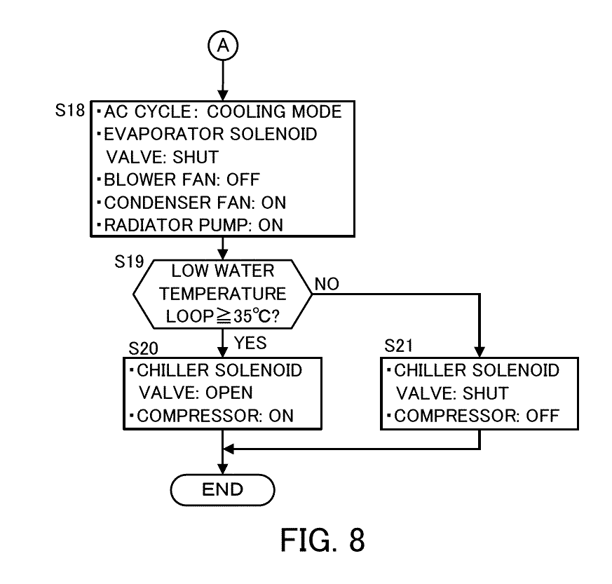

Next, the details of processing executed by the controller 70 of the thermal management system for the electric vehicle 100 will be explained with reference to FIG. 7 and FIG. 8. FIG. 7 and FIG. 8 are flowcharts illustrating the processing executed by the controller 70 when the vehicle is in a driving state (the state in which the driver is seated in the vehicle). Control processing as illustrated in FIG. 7 and FIG. 8 is repeatedly executed per a micro period.

In a step S1, the controller 70 decides whether the blower fan 3 is operated or not. When it is decided that the blower fan 3 is operated, the processing proceeds to a step S2, and when it is decided that the blower fan 3 is not operated, the processing proceeds to a step S18 in FIG. 8. It is decided that the blower fan 3 is operated when the air conditioning unit of the vehicle is operated, such as when, for example, the driver uses the A/C controller 75 to operate the air conditioning.

In the step S2, the controller 70 calculates the target blowout temperature. The target blowout temperature is calculated based on the set temperature of the air conditioning unit, the temperature of the air inside the cabin, the temperature of the outside air, the solar radiation amount to be received by the vehicle, and the like. When, for example, an automatic mode is set by the driver pressing an AUTO switch in the A/C controller 75, the target blowout temperature is calculated automatically in such a manner that the temperature of the air inside the cabin becomes the set temperature.

In a step S3, the controller 70 decides whether a heating request is made or not. When it is decided that the heating request is made, the processing proceeds to a step S4, and when it is decided that the heating request is not made, the processing proceeds to a step S14. Whether the heating request is made or not is determined based on the target blowout temperature and the temperature of the air inside the cabin. For example, it is determined that the heating request is made when the target blowout temperature is higher than the temperature of the air inside the cabin, and it is determined that a cooling request is made when the target blowout temperature is lower than the temperature of the air inside the cabin.

In the step S4, the controller 70 sets an air conditioning cycle of the air conditioning unit to a heating mode, sets the evaporator solenoid valve 22 to be in an open state, and sets the air conditioning unit (HVAC) to the automatic mode. Thereby, the air quantity of the blower fan 3 and door positions of the respective doors (the intake door, the mix door, the defroster door, the vent door, and the foot door) are automatically controlled so that the temperature inside the cabin becomes the set temperature. The condenser fan 2 and the radiator pump 31 are stopped correspondingly.

In a step S5, the controller 70 decides whether the temperature of the cooling water in the low water temperature loop 50 is 15° C. or less or not. When it is decided that the temperature of the cooling water is 15° C. or less, the processing proceeds to a step S6, and when it is decided that the temperature is higher than 15° C., the processing proceeds to a step S7. A threshold value of the decision, which is 15° C. in this step, is appropriately set to be a lower limit value of the temperature that is preferable for the operation, based on specifications of the battery 1.

In the step S6, the controller 70 operates the hot water heater 54.

In the step S7, the controller 70 stops the hot water heater 54.

In a step S8, the controller 70 decides whether the temperature of the cooling water in the low water temperature loop 50 is 35° C. or more or not. When it is decided that the temperature of the cooling water is 35° C. or more, the processing proceeds to a step S10, and when it is decided that the temperature is less than 35° C., the processing proceeds to a step S9. A threshold value of the decision, which is 35° C. in this step, is appropriately set to be an upper limit value of the temperature that is preferable for the operation, based on the specifications of the battery 1.

In the step S9, the controller 70 executes blowout temperature following control of the compressor 11. The blowout temperature following control is control by which the rotation speed of the compressor 11 is adjusted so that the target blowout temperature becomes the desired temperature, in the automatic mode of the air conditioning unit that is set in the step S4.

In the step S10, the controller 70 controls the rotation speed of the compressor 11 in such a manner that the temperature of the cooling water in the low water temperature loop 50 becomes 35° C.

Namely, when the temperature of the cooling water in the low water temperature loop 50 is 35° C. or more, in the steps S8 to S10, it is determined that heating capacity is more than enough, and the controller 70 controls the compressor 11 in such a manner that the temperature of the cooling water is kept at 35° C.

In a step S11, the controller 70 decides whether the temperature of the cooling water in the high water temperature loop 30 is water temperature Xm or more or not. When it is decided that the temperature of the cooling water is the water temperature Xm or more, the processing proceeds to a step S12, and when it is decided that the temperature of the cooling water is lower than the water temperature Xm, the processing proceeds to a step S13. The water temperature Xm is the target blowout temperature that is calculated in the step S2.

In the step S12, the controller 70 allows the high water temperature loop 30 to function as a radiator circuit, and operates the condenser fan 2. The radiator circuit means a heater core circuit, in which the cooling water in the high water temperature loop 30 circulates through the heater core 35, as illustrated in FIG. 5, added with a circuit, in which the cooling water also circulates through the radiator 32 by the driven radiator pump 31. In the radiator circuit, the cooling water discharges the heat that is absorbed in the water condenser 16 to the cabin, in the heater core 35, and also discharges the heat to the outside of the cabin, in the radiator 32. Namely, when the temperature of the cooling water in the high water temperature loop 30 is the water temperature Xm or more, the cooling water in the high water temperature loop 30 is forcibly cooled by the radiation by the radiator.

In the step S13, the controller 70 allows the high water temperature loop 30 to function as the heater core circuit, and stops the condenser fan 2. The heater core circuit means a circuit in which the cooling water in the high water temperature loop 30 circulates through the heater core 35 and the water condenser 16, as illustrated in FIG. 5. In this case, the cooling water in the high water temperature loop 30 is not radiated by the radiator.

Meanwhile, when it is decided in the step S3 that the heating request is not made, the processing proceeds to the step S14, where the controller 70 sets the air conditioning cycle of the air conditioning unit to the cooling mode, sets the evaporator solenoid valve 22 to be in the open state, and sets the air conditioning unit (HVAC) to the automatic mode. Thereby, the air quantity of the blower fan 3 and the door positions of the respective doors (the intake door, the mix door, the defroster door, the vent door, and the foot door) are automatically controlled so that the temperature inside the cabin becomes the set temperature. The condenser fan 2 and the radiator pump 31 are operated correspondingly.

In a step S15, the controller 70 decides whether the temperature of the cooling water in the low water temperature loop 50 is 35° C. or less or not. When it is decided that the temperature of the cooling water is 35° C. or less, the processing proceeds to a step S16, and when it is decided that the temperature is higher than 35° C., the processing proceeds to a step S17. A threshold value of the decision, which is 35° C. in this step, is appropriately set to be an upper limit value of the temperature that is preferable for the operation, based on the specifications of the battery 1.

In the step S16, the controller 70 shuts off the chiller solenoid valve 23, and controls the compressor 11 so that the temperature of air immediately after the evaporator 14 in the air conditioning unit becomes 3° C. (3° C. control immediately after the evaporator).

In the step S17, the controller 70 opens the chiller solenoid valve 23, and controls the compressor so that the temperature of the air immediately after the evaporator 14 in the air conditioning unit becomes 3° C.

Namely, during the cooling mode, the compressor 11 is controlled so that the temperature of the air immediately after the evaporator 14 becomes 3° C., irrespective of the temperature of the battery and, when the temperature of the cooling water in the low water temperature loop 50 is 35° C. or more, the heat is absorbed via the chiller 17.

Meanwhile, when it is decided in the step S1 that the blower fan 3 is stopped, the processing proceeds to the step S18 in FIG. 8, where the controller 70 sets the air conditioning cycle of the air conditioning unit to the cooling mode, and sets the evaporator solenoid valve 22 to be in a closed state. The condenser fan 2 and the radiator pump 31 are operated correspondingly.

In a step S19, the controller 70 decides whether the temperature of the cooling water in the low water temperature loop 50 is 35° C. or more or not. When it is decided that the temperature of the cooling water is 35° C. or more, the processing proceeds to a step S20, and when it is decided that the temperature is lower than 35° C., the processing proceeds to a step S21.

In the step S20, the controller 70 opens the chiller solenoid valve 23 and operates the compressor 11. Thereby, the refrigerant in the air conditioner loop 10 flows to the chiller 17, and heat is absorbed from the cooling water in the low water temperature loop 50.

In the step S21, the controller 70 shuts off the chiller solenoid valve 23, and stops the compressor 11. Thereby, the flow of the refrigerant in the air conditioner loop 10 is stopped.

Namely, when the temperature of the battery is high, the heat is absorbed from the chiller 17 and the heat is radiated from the condenser 12, even when the air conditioning is turned off.

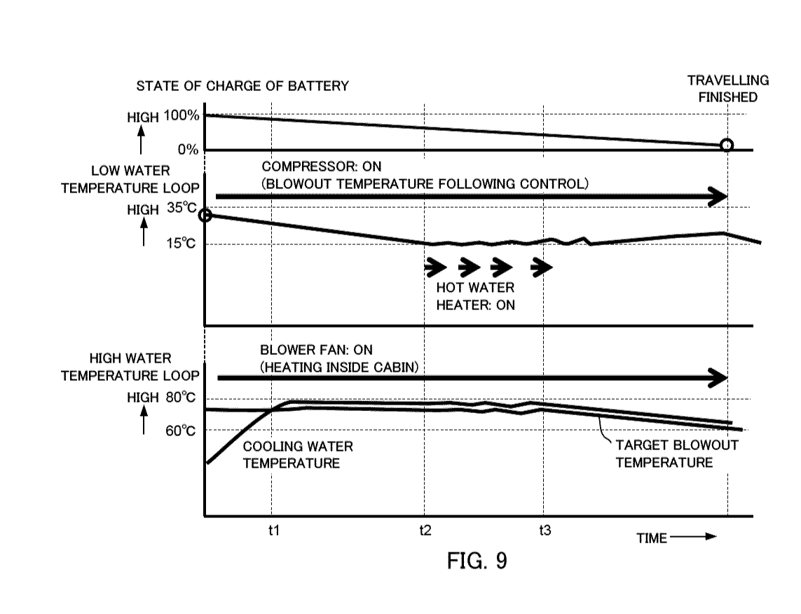

Next, the function of the thermal management system for the electric vehicle 100 when the vehicle is travelling will be explained with reference to FIG. 9 to FIG. 11.

FIG. 9 illustrates the case that requires much heating heat in winter or the like when the temperature of the outside air is low. In this case, the air conditioning cycle is set to the heating mode, the compressor 11 is subjected to the blowout temperature following control, and the blower fan 3 is operated to send warm air into the cabin.

When the vehicle travels, a state of charge of the battery 1 is reduced gradually. At this time, the heat generated by an electric discharge of the battery 1 is absorbed in the cooling water in the low water temperature loop 50, via the water jacket 55. Further, the cooling water in the low water temperature loop 50 is warmed up in advance at the time of charging and is storing heat. As the cooling water is circulated by the battery pump 51, the heat of the cooling water in the low water temperature loop 50 is absorbed in the refrigerant in the air conditioner loop 10, via the chiller 17. Thereby, the temperature of the cooling water in the low water temperature loop 50 is gradually reduced.

In the high water temperature loop 30, heat is absorbed from the refrigerant in the air conditioner loop 10, via the water condenser 16. In addition, the heat generated by driving the motor 33 is added thereto, and the temperature of the cooling water increases. Thus, the heat stored in the low water temperature loop 50 at the time of charging is transferred to the high water temperature loop 30, so that the temperature of the cooling water in the high water temperature loop 30 can be increased quickly.

When the temperature of the cooling water in the high water temperature loop 30 reaches the target blowout temperature at a time t1, the rotation speed of the compressor 11 is reduced and a flow rate of the refrigerant in the air conditioner loop 10 is reduced. After that, the compressor 11 is subjected to the blowout temperature following control, and the amount of the heat absorbed from the water condenser 16 to the high water temperature loop 30 is adjusted so that the temperature of the cooling water in the high water temperature loop 30 becomes the target blowout temperature.

When the temperature of the cooling water in the low water temperature loop 50 falls below 15° C. at a time t2, the hot water heater 54 is operated. The hot water heater 54 is subjected to ON/OFF control or continuous operation in such a manner that the temperature of the cooling water in the low water temperature loop 50 does not fall below 15° C.

When the temperature of the air inside the cabin is increased by the heating, or when the temperature of the outside air increases, at a time t3, the target blowout temperature is reduced. When the target blowout temperature is reduced, the rotation speed of the compressor 11 is reduced, and the water temperature in the high water temperature loop 30 is also reduced.

When the rotation speed of the compressor 11 is reduced, a heat absorbing amount of the refrigerant in the chiller 17 is reduced, and hence the temperature of the cooling water in the low water temperature loop 50 is increased. In this case, the temperature of the cooling water in the low water temperature loop 50 is increased by the waste heat of the battery 1, the inverter 53, and the DC/DC converter 52.

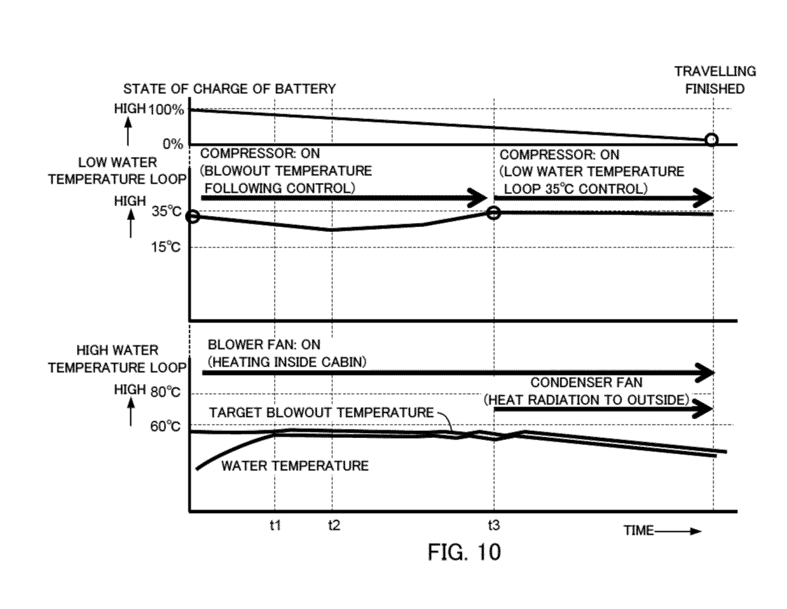

FIG. 10 illustrates the case that does not require much heating heat in winter, spring, fall or the like when the temperature of the outside air is relatively low. In this case, the air conditioning cycle is set to the heating mode, the compressor 11 is switched between the blowout temperature following control and the low water temperature loop 35° C. control according to the temperature of the cooling water in the low water temperature loop 50, and the blower fan 3 is operated to send the warm air into the cabin.

When the vehicle travels, the state of charge of the battery 1 is reduced gradually. At this time, the heat generated by the electric discharge of the battery 1 is absorbed in the cooling water in the low water temperature loop 50, via the water jacket 55. Further, the cooling water in the low water temperature loop 50 is warmed up in advance at the time of charging and is storing heat. As the cooling water is circulated by the battery pump 51, the heat of the cooling water in the low water temperature loop 50 is absorbed in the refrigerant in the air conditioner loop 10, via the chiller 17. Thereby, the temperature of the cooling water in the low water temperature loop 50 is gradually reduced.

In the high water temperature loop 30, heat is absorbed from the refrigerant in the air conditioner loop 10, via the water condenser 16. In addition, heat generated by driving the motor 33 is added thereto, and the temperature of the cooling water increases. Thus, the heat stored in the low water temperature loop 50 at the time of charging is transferred to the high water temperature loop 30, so that the temperature of the cooling water in the high water temperature loop 30 can be increased quickly.

When the temperature of the cooling water in the high water temperature loop 30 reaches the target blowout temperature at a time t1, the rotation speed of the compressor 11 is reduced and the flow rate of the refrigerant in the air conditioner loop 10 is reduced. After that, the compressor 11 is subjected to the blowout temperature following control, and the amount of heat absorbed from the water condenser 16 to the high water temperature loop 30 is adjusted so that the temperature of the cooling water in the high water temperature loop 30 becomes the target blowout temperature.

In this state, the temperature of the outside air is not so low and the target blowout temperature is lower than the case of FIG. 9, and hence the rotation speed of the compressor 11 is reduced earlier than the case of FIG. 9. When the rotation speed of the compressor 11 is reduced, the heat absorbing amount in the chiller 17 is reduced. When the amount of the waste heat of the battery 1, the inverter 53, and the DC/DC converter 52 becomes greater than the heat absorbing amount of the chiller 17, at a time t2, the temperature of the cooling water in the low water temperature loop 50 is increased.

When the temperature of the cooling water in the low water temperature loop 50 reaches 35° C. at a time t3, the control of the compressor 11 is switched to the low water temperature loop 35° C. control. In this case, the heating capacity is more than enough, and the compressor 11 is controlled in such a manner that the temperature of the cooling water in the low water temperature loop 50 does not exceed 35° C., irrespective of the target blowout temperature.

Thereby, the rotation speed of the compressor 11 does not follow the target blowout temperature, and the temperature of the cooling water in the high water temperature loop 30 exceeds the target blowout temperature. Thus, the high water temperature loop 30 is set as the radiator circuit, and the condenser fan 2 is operated. The temperature of the cooling water in the high water temperature loop 30 is allowed to follow the target blowout temperature by the radiation by the radiator.

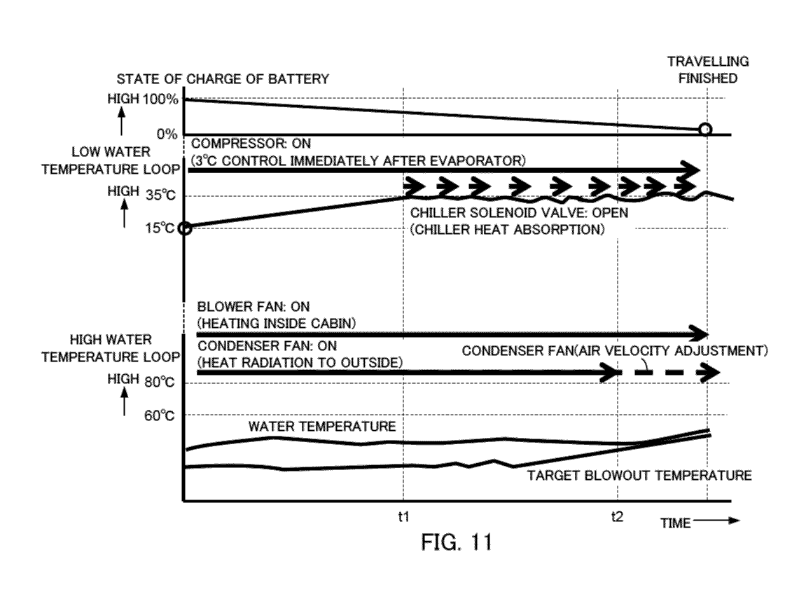

FIG. 11 illustrates the case that requires cooling of the battery 1 in summer when the temperature of the outside air is high. In this case, the air conditioning cycle is set to the cooling mode, the compressor 11 is subjected to the 3° C. control immediately after the evaporator, and the blower fan 3 is operated to send cool air into the cabin. In addition, the condenser fan 2 and the radiator pump 31 are operated.

When the vehicle travels, the state of charge of the battery 1 is reduced gradually. At this time, the heat generated by the electric discharge of the battery 1 is absorbed in the cooling water in the low water temperature loop 50, via the water jacket 55. As the temperature of the cooling water in the low water temperature loop is 35° C. or less, the chiller solenoid valve 23 is shut off and the refrigerant does not flow through the chiller 17. Namely, priority is placed on the cooling of the introduced air in the evaporator 14, and hence the heat is not absorbed from the low water temperature loop 50. Thus, the temperature of the cooling water in the low water temperature loop 50 is gradually increased by the waste heat of the battery 1, the inverter 53, and the DC/DC converter 52.

In the high water temperature loop 30, the cooling water circulates through the motor 33 and the radiator 32. Thus, the heat is not transferred to the refrigerant in the air conditioner loop 10, and the heat, by the amount generated by the motor 33, is radiated from the radiator 32. Therefore, the temperature of the cooling water does not necessarily agree with the target blowout temperature.

When the temperature of the cooling water in the low water temperature loop 50 reaches 35° C. at a time t1, the chiller solenoid valve 23 is opened. Thereby, the refrigerant in the air conditioner loop 10 flows to the chiller 17 and, in the chiller 17, heat is absorbed from the cooling water in the low water temperature loop 50. The chiller solenoid valve 23 is opened/closed in such a manner that the temperature of the cooling water in the low water temperature loop 50 is kept nearly at 35° C.

When the temperature of the air inside the cabin increases or when the temperature of the outside air reduces, the target blowout temperature is increased. Then, at a time t2, air velocity of the condenser fan 2 is adjusted so that the temperature of the cooling water in the high water temperature loop becomes the target blowout temperature. In this case, the condenser fan 2 may be subjected to the ON/OFF control, or to the continuous operation with a low rotation speed.

According to this embodiment as described thus far, the cooling water in the low water temperature loop 50 is heated by the hot water heater 54 when its temperature is lower than 15° C., and the heat is absorbed by the chiller 17 when its temperature is higher than 35° C., as a result of which the temperature of the battery 1 can be kept within a desired temperature range. Further, the heat stored in the low water temperature loop 50 at the time of charging and the waste heat of the battery 1 are absorbed in the refrigerant in the air conditioner loop 10, via the chiller 17, which makes it possible to use the heat, stored at the time of charging, effectively for the air conditioning in the cabin, and to suppress the reduction in cruising distance of the vehicle by suppressing consumption power caused by the operation of the air conditioning.

Further, when the heating request is made, the compressor 11 is subjected to the blowout temperature following control. Thus, the heat in the low water temperature loop 50 can be absorbed, in the chiller 17, by a necessary amount, and can be transferred to the high water temperature loop 30 via the water condenser 16. Thus, the heat stored in the low water temperature loop 50 at the time of charging can be efficiently used as the heating heat.

Furthermore, when the heating request is made and when the temperature of the low water temperature loop 50 is 35° C. or more, the compressor 11 is subjected to the low water temperature loop 35° C. control. Thus, even when the heating heat is more than enough, the temperature of the cooling water in the low water temperature loop 50 (the temperature of the battery) can be kept at 35° C. or less. Moreover, the excess heat can be sent to the high water temperature loop 30 via the water condenser 16, and the heat can be radiated from the radiator 32 to the outside air. This makes it possible to keep the temperature of the battery 1 within the desired temperature range with more reliability.

Further, when the temperature of the cooling water in the low water temperature loop 50 is equal to or less than the target temperature of the low water temperature loop 50, the electric hot water heater 54 that is operated by the power supplied from the battery 1 is used. This makes it possible to use the chiller 17 specially for transferring heat from the low-temperature cooling water to the refrigerant side, and to avoid a reduction in a following property of the air conditioner loop 10, due to up-and-down fluctuations in the temperature of the battery.

Furthermore, when the cooling request is made, the compressor 11 is subjected to the 3° C. control immediately after the evaporator, and when the temperature of the cooling water in the low water temperature loop 50 is 35° C. or less, the evaporator solenoid valve 22 is shut off and all the refrigerant is flowed to the evaporator 14. This makes it possible to place priority on the cooling capacity and to cool the temperature of the air inside the cabin more quickly. Moreover, when the temperature of the cooling water in the low water temperature loop 50 is higher than 35° C., the refrigerant is flowed to the chiller 17, so as to absorb the heat by the amount generated by the battery 1. This makes it possible to keep the temperature of the battery 1 within the desired temperature range, even at the time of cooling.

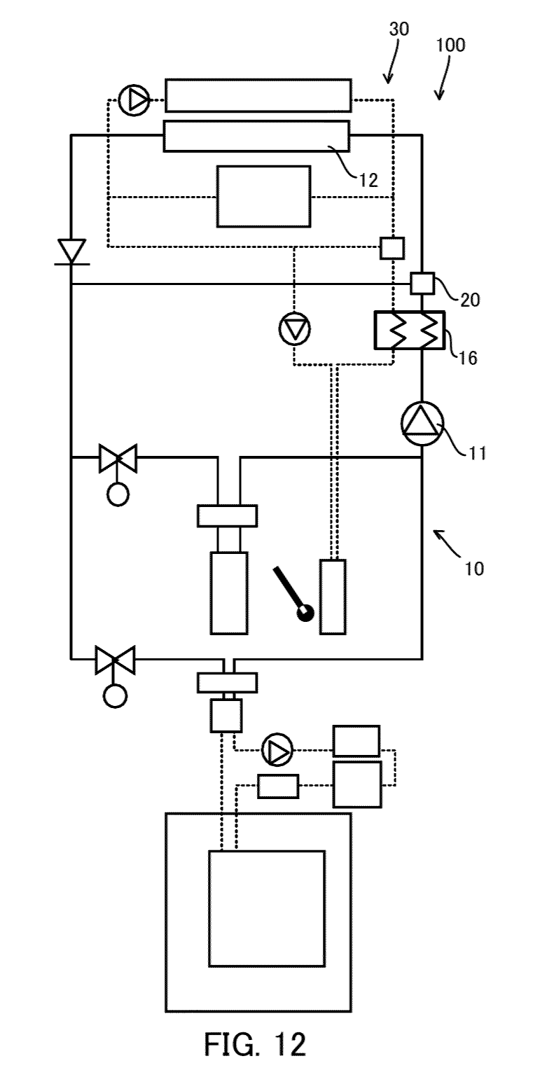

Next, modification examples of the thermal management system for the electric vehicle 100 will be explained with reference to FIG. 12 to FIG. 17.

FIG. 12 illustrates a first modification example of the thermal management system for the electric vehicle 100.

According to the first modification example, the position where the water condenser 16 is provided is different from that of the above-described embodiment. The water condenser 16 is disposed at the same position in the high water temperature loop 30, but in the air conditioner loop 10, it is provided between the compressor 11 and the three way valve 20. Namely, the water condenser 16 and the condenser 12 are provided in parallel with each other along the air conditioner loop 10 according to the above-described embodiment. However, according to this modification example, the water condenser 16 and the condenser 12 are provided in series. Thereby, the cooling water in the high water temperature loop 30 absorbs heat from the refrigerant at all times, irrespective of the switching position of the three way valve 20, which makes it possible to improve a heat radiation property of the air conditioner loop 10.

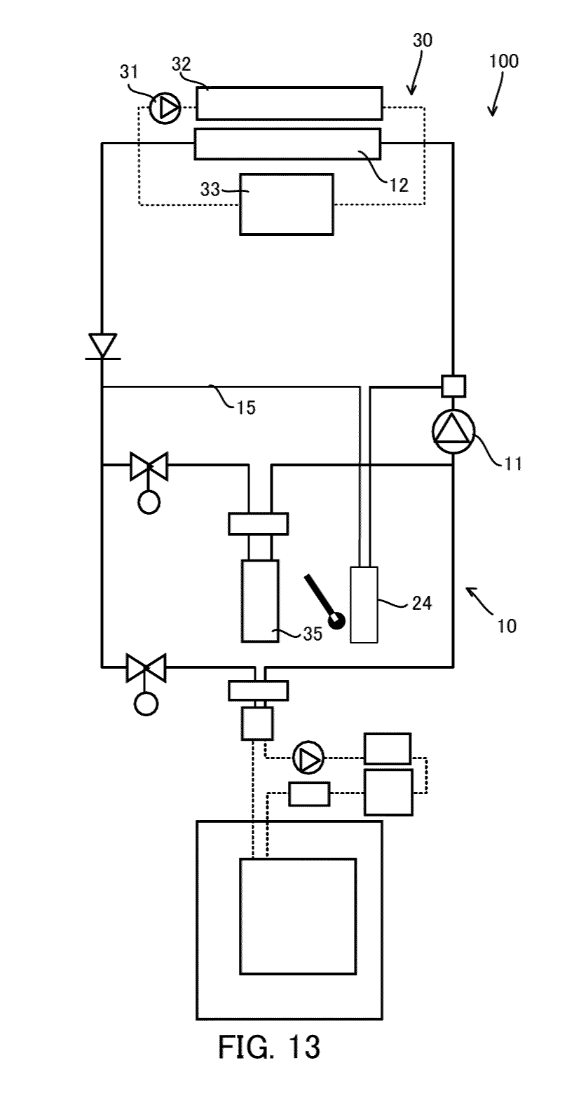

FIG. 13 illustrates a second modification example of the thermal management system for the electric vehicle 100.

According to the second modification example, the structure of the high water temperature loop 30 and the air conditioner loop 10 is different from that of the above-described embodiment. With regard to the high water temperature loop 30, the water condenser 16, the water switching valve 37, the H/C pump 34, and the heater core 35 are removed from the high water temperature loop 30 of the above-described embodiment, so as to obtain a circuit in which the cooling water, sent from the radiator pump 31, circulates through the radiator 32 and the motor 33.

In addition, in the air conditioner loop 10, an inner condenser 24 is provided on the bypass passage 15 that connects the downstream side of the compressor 11 and the downstream side of the condenser 12. The inner condenser 24 is provided inside the air conditioning unit, similarly to the heater core 35 of the above-described embodiment.

According to this modification example, the water condenser 16 is omitted and hence the heat exchange cannot be performed between the air conditioner loop 10 and the high water temperature loop 30. However, it is possible to simplify the structure of the high water temperature loop 30.

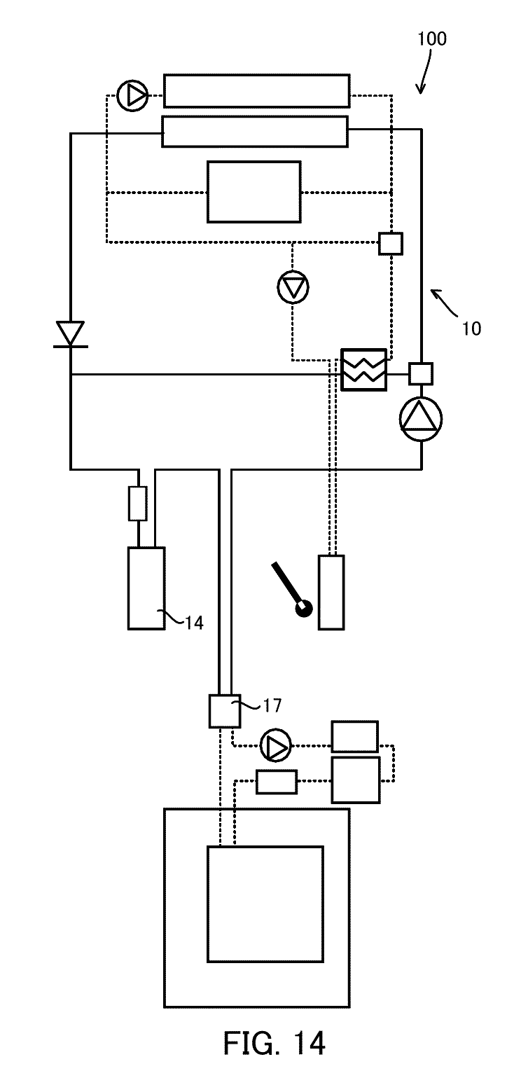

FIG. 14 illustrates a third modification example of the thermal management system for the electric vehicle 100.

According to the third modification example, the structure of the air conditioner loop 10 is different from that of the above-described embodiment. According to the above-described embodiment, the evaporator 14 and the chiller 17 in the air conditioner loop 10 are connected in parallel. However, according to this modification example, the evaporator 14 and the chiller 17 are connected in series in this order.

According to this modification example, the passage 19 and the solenoid valves 22 and 23 in the air conditioner loop 10 can be omitted, and hence its structure can be simplified.

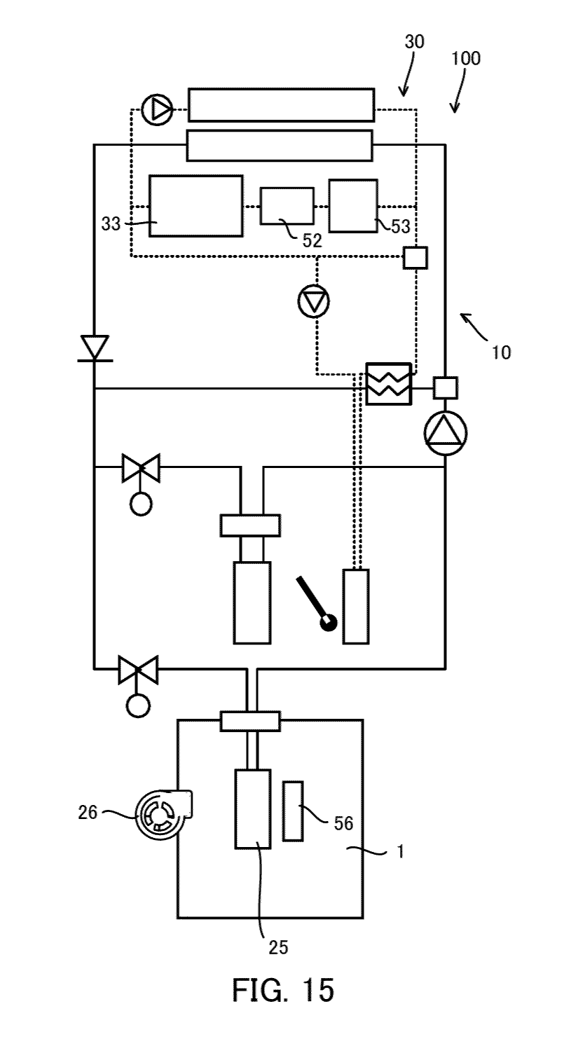

FIG. 15 illustrates a fourth modification example of the thermal management system for the electric vehicle 100.

According to the fourth modification example, the structure of the high water temperature loop 30 and the air conditioner loop 10 is different from that of the above-described embodiment. In addition, air is used, instead of the cooling water, as the refrigerant in the low water temperature loop 50. Namely, a fan 26 is used to cool the battery 1 by air. An air heater 56 is used to heat the battery. In the high water temperature loop 30, the DC/DC converter 52 and the inverter 53 are arranged in series to the motor 33 of the above-described embodiment. In the air conditioner loop 10, an evaporator 25 is provided instead of the chiller 17 of the above-described embodiment, and this evaporator 25 is arranged next to the battery 1.

According to this modification example, the temperature of the battery 1 can be adjusted appropriately by adjusting operation status of the evaporator 25 and the hot water heater 54. In addition, a cooling system of the battery 1 can be simplified as the cooling water in the low water temperature loop 50 is omitted.

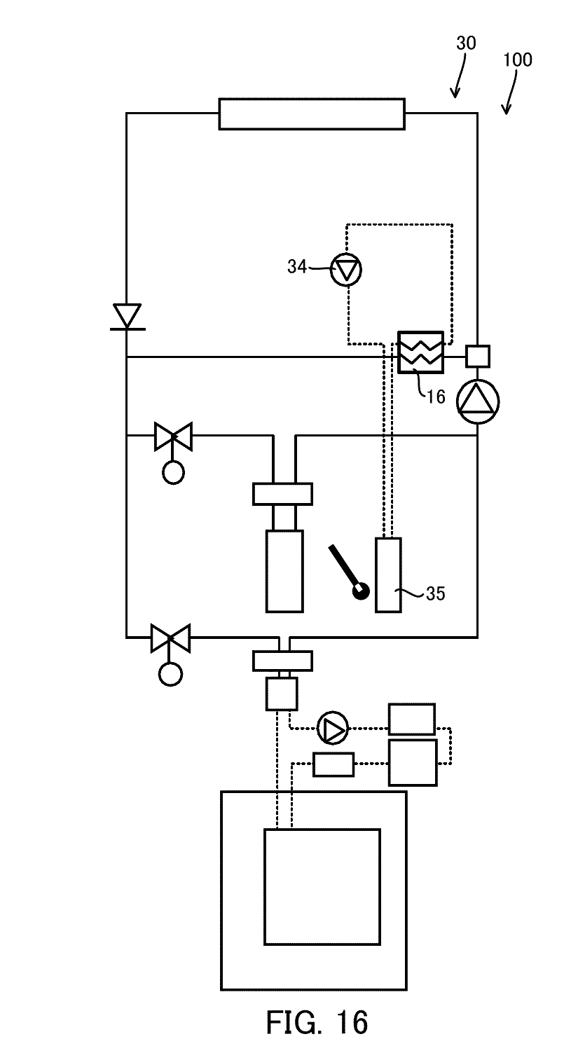

FIG. 16 illustrates a fifth modification example of the thermal management system for the electric vehicle 100.

The fifth modification example assumes that the vehicle employs an in-wheel motor, housed inside a driving wheel, as the motor for driving the vehicle. According to this modification example, the structure of the high water temperature loop 30 is different from that of the above-described embodiment.

With regard to the high water temperature loop 30, the motor 33, the radiator pump 31, the radiator 32, and the water switching valve 37 are removed from the high water temperature loop 30 of the above-described embodiment, so as to obtain a circuit in which the cooling water, sent from the H/C pump 34, circulates through the heater core 35 and the water condenser 16.

According to this modification example, it is possible to realize the thermal management system 100 that is similar to the above-described embodiment, even in the vehicle on which the in-wheel motor is mounted.

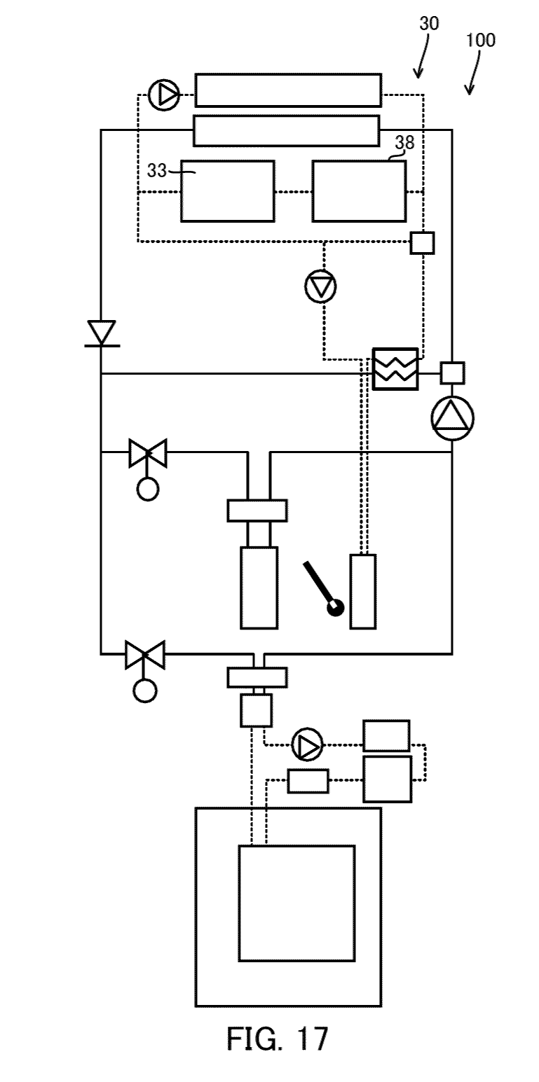

FIG. 17 illustrates a sixth modification example of the thermal management system for the electric vehicle 100.

The sixth modification example assumes that the vehicle is provided with both of the motor 33 and an engine 38, such as a hybrid vehicle and a range extender EV vehicle. According to this modification example, the structure of the high water temperature loop 30 is different from that of the above-described embodiment. In the high water temperature loop 30, the engine 38 is arranged in series to the motor 33 of the above-described embodiment.

According to this modification example, it is possible to realize the thermal management system 100 that is similar to the above-described embodiment, by effectively using the waste heat of the engine 38, even in the vehicle on which the engine 38 is mounted.

The embodiments of the present invention have been explained thus far. However, the above-described embodiments are only application examples of the present invention, and are not intended to limit the technical scope of the present invention to the concrete configuration of the above-described embodiments.

For example, the threshold value of the temperature of the cooling water in the low water temperature loop 50, used for deciding whether the hot water heater 54 should be operated or not, is set at 15° C. according to the above-described embodiment. However, the threshold value may be set at the different temperature within a temperature range that is suitable for the operation of the battery 1 provided in the low water temperature loop 50.

Further, the threshold value of the temperature of the cooling water in the low water temperature loop 50, used for deciding whether the control of the compressor 11 should be switched or not, is set at 35° C. However, the threshold value may be set at the different temperature within the temperature range that is suitable for the operation of the battery 1 provided in the low water temperature loop 50.

Furthermore, the threshold value of the temperature of the cooling water in the low water temperature loop 50, used for deciding whether the chiller solenoid valve 23 should be opened/closed or not, is set at 35° C. However, the threshold value may be set at the different temperature within the temperature range that is suitable for the operation of the battery 1 provided in the low water temperature loop 50.

Further, the above-described threshold values, which are 15° C. and 35° C., may be different between the case when the water temperature is increasing and the case when the water temperature is decreasing, by providing differential (hysteresis) to prevent chattering.

Furthermore, the antifreeze has been used as an example to explain the cooling water of the low water temperature loop 50 and the high water temperature loop 30, but other refrigerants, such as oil, may be employed.

The present application claims priority to Japanese Patent Application No. 2012-179330, filed in the Japan Patent Office on Aug. 13, 2012. The contents of this application are incorporated herein by reference in their entirety.

1. A thermal management system for an electric vehicle that is used in the electric vehicle driven by an electric motor, comprising:
a refrigerant loop for an air conditioner that includes a compressing unit for compressing a refrigerant for the air conditioner, a condensing unit for condensing the refrigerant for the air conditioner by radiating heat of the refrigerant for the air conditioner, a pressure reducing unit for expanding and reducing pressure of the refrigerant for the air conditioner, and an evaporating unit for evaporating the refrigerant for the air conditioner by allowing the refrigerant for the air conditioner to absorb heat, and that allows the refrigerant for the air conditioner to circulate;
a refrigerant loop for a battery that allows a refrigerant for the battery to circulate among the battery that accumulates power to be supplied to the electric motor, the evaporating unit that is common to the refrigerant loop for the air conditioner, and a heating device that heats the refrigerant for the battery; and
a thermal management controlling unit adapted to heat the refrigerant for the battery by using the heating device when temperature of the refrigerant for the battery is lower than allowable lower-limit temperature of the battery, during when an air conditioning unit for adjusting temperature of air inside a cabin is in operation, and reduce the temperature of the refrigerant for the battery to be equal to or lower than allowable upper-limit temperature of the battery by increasing an output of the compressing unit when the temperature of the refrigerant for the battery is higher than the allowable upper-limit temperature of the battery.

2. The thermal management system for the electric vehicle according to claim 1, further comprising:
a refrigerant loop for a heater that allows a refrigerant for the heater to circulate between the condensing unit that is common to the refrigerant loop for the air conditioner, and an in-vehicle radiating device that radiates heat from the refrigerant for the heater to air introduced inside the vehicle;
a temperature status deciding unit adapted to decide whether target blowout temperature of the air conditioning unit is higher than the temperature of the air inside the cabin or the target blowout temperature is lower than the temperature of the air inside the cabin; and
a target temperature calculating unit adapted to calculate target temperature of the refrigerant for the heater based on temperature status, temperature of outside air, and the temperature of the air inside the cabin,
wherein, when the target blowout temperature is higher than the temperature of the air inside the cabin, the thermal management controlling unit allows temperature of the refrigerant for the heater to follow the target temperature by controlling the output of the compressing unit.

3. The thermal management system for the electric vehicle according to claim 2,
wherein the refrigerant loop for the heater includes an out-of-vehicle radiating device that radiates heat from the refrigerant for the heater to air outside the vehicle, and
wherein, when the target blowout temperature of the air conditioning unit is higher than the temperature of the air inside the cabin, and when the temperature of the refrigerant for the battery is higher than the allowable upper-limit temperature, the thermal management controlling unit allows the temperature of the refrigerant for the heater to follow the target temperature by controlling an amount of heat radiation of the out-of-vehicle radiating device.

4. The thermal management system for the electric vehicle according to claim 1,
wherein the heating device comprises an electric heater that is operated by power supplied from the battery.

5. The thermal management system for the electric vehicle according to claim 1,
wherein the evaporating unit is formed by a first evaporating device, in which the refrigerant for the air conditioner absorbs heat from air introduced inside the vehicle, and a second evaporating device provided along the refrigerant loop for the air conditioner in parallel with the first evaporating device, in which the refrigerant for the air conditioner absorbs heat from the refrigerant for the battery,
wherein a switching unit adapted to allow the refrigerant for the air conditioner to circulate to at least one of a side of the first evaporating device and a side of the second evaporating device is provided, and
wherein the thermal management controlling unit allows the refrigerant for the air conditioner to flow to the first evaporating device when target blowout temperature of the air conditioning unit is lower than the temperature of the air inside the cabin, and allows the refrigerant for the air conditioner to flow to the second evaporating device only when the temperature of the refrigerant for the battery is higher than the allowable upper-limit temperature.

6. The thermal management system for the electric vehicle according to claim 1,
wherein the evaporating unit is formed by a first evaporating device, in which the refrigerant for the air conditioner absorbs heat from air introduced inside the vehicle, and a second evaporating device provided along the refrigerant loop for the air conditioner in series with the first evaporating device, in which the refrigerant for the air conditioner absorbs heat from the refrigerant for the battery.

7. The thermal management system for the electric vehicle according to claim 1,
wherein air is used as the refrigerant for the battery in the refrigerant loop for the battery.

8. A control method of a thermal management system for an electric vehicle that is used in the electric vehicle driven by an electric motor,
wherein the thermal management system for the electric vehicle comprises
a refrigerant loop for an air conditioner that includes a compressing unit for compressing a refrigerant for the air conditioner, a condensing unit for condensing the refrigerant for the air conditioner by radiating heat of the refrigerant for the air conditioner, a pressure reducing unit for expanding and reducing pressure of the refrigerant for the air conditioner, and an evaporating unit for evaporating the refrigerant for the air conditioner by allowing the refrigerant for the air conditioner to absorb heat, and that allows the refrigerant for the air conditioner to circulate, and
a refrigerant loop for a battery that allows a refrigerant for the battery to circulate among the battery that accumulates power to be supplied to the electric motor, the evaporating unit that is common to the refrigerant loop for the air conditioner, and a heating device that heats the refrigerant for the battery,
wherein the control method comprises
heating the refrigerant for the battery by using the heating device when temperature of the refrigerant for the battery is lower than allowable lower-limit temperature of the battery, during when an air conditioning unit for adjusting temperature of air inside a cabin is in operation, and
reducing the temperature of the refrigerant for the battery to be equal to or lower than allowable upper-limit temperature of the battery by increasing an output of the compressing unit when the temperature of the refrigerant for the battery is higher than the allowable upper-limit temperature of the battery.
